(19) United States
(12) Patent Application Publication
(10) Pub. No.: US 2025/0045734 A1
(43) Pub. Date: Feb. 6, 2025

(54) COMMUNICATION SYSTEM AND PROGRAM

(71) Applicant: Omochanokuni Toyland Co., Ltd., Tokyo (JP)

(72) Inventors: Mikio FUJII, Tokyo (JP); Kyouko FUJII, Tokyo (JP); Atsumasa FUJII, Tokyo (JP); Katsuhide FUJII, Tokyo (JP)

(73) Assignee: Omochanokuni Toyland Co., Ltd., Tokyo (JP)

(21) Appl. No.: 18/718,944

(22) PCT Filed: Jul. 22, 2022
(86) PCT No.: PCT/JP2022/028483

§ 371 Date: Jun. 12, 2024

(30) Foreign Application Priority Data
Dec. 15, 2021 (JP) 2021-203431

(51) Int. Cl. G06Q 20/36; G06Q 20/38

(52) U.S. Cl. CPC G06Q 20/3674; G06Q 20/389

(57) ABSTRACT

A communication system including a distributed ledger unit, a communication management unit, and a plurality of user information terminals. The distributed ledger unit is configured to generate and store fungible tokens and non-fungible tokens, and to send and receive fungible and/or non-fungible tokens between users. The user information terminals each include a user-specific wallet unit for management of fungible tokens and non-fungible tokens, and are configured to be able to send to the distributed ledger unit an instruction in accordance with an input from a user to generate and store fungible tokens and/or non-fungible tokens, and to send and receive fungible tokens and/or non-fungible tokens between users. The communication management unit is configured to be able to acquire, and aggregate and analyze, information on a processing result of fungible tokens and/or non-fungible tokens in the distributed ledger unit, as well as to output the information.

### TECHNICAL FIELD

The present invention relates to a communication system and a program for implementing intercommunication between a plurality of users.

### BACKGROUND ART

Non-fungible tokens (NFTs) are finding more and more applications as described in Patent Document 1. The non-fungible token is a unique and non-replaceable token that is recorded through blockchain technology. Any digital files of images, movies, audio, and any other digital data have an inherent characteristic of being easily copied. Adding an NFT to such digital data allows the data to be treated as a unique item.

Patent Document 1, for example, describes an attempt in which a non-fungible token, NFT, is added to so-called in-game assets such as game item characters, etc., to allow these in-game assets to be readily sent not only within the game but also out of the game, and/or to allow in-game assets in another game to be received from outside the game.

Meanwhile, the recent years have seen the wide spread of various SNSs (Social Networking Services) such as video distribution SNSs and image-posting SNSs. Management of the digital content sent and received on these SNSs, i.e., checking whether the content was created by the sender himself/herself, relies only on the “terms of use” or the like.

These content distribution or posting SNSs have opened up opportunities for a variety of creators, and have accelerated earlier discovery of talents, in particular, young talented creators (e.g., young Youtubers).

In view of the current situation where the blockchain technology and non-fungible tokens, NFTs, are expected to find further applications in near future, it is desirable for such young users to start using and familiarizing themselves with the blockchain technology (including fungible and non-fungible tokens) earlier. Due to the need to open an account when starting to use a system, there is, currently, no system that young users can easily start using.

### CITATION LIST

### Patent Document

Patent Document 1: Patent Publication JP-A-2021-152815

### SUMMARY

### Technical Problem

Accordingly, an object of the present invention is to provide a communication system that is easy to use for users without expert knowledge of blockchain technology and the like, and even for young users in particular, the system allowing addition of a non-fungible token, NFT, to user-created electronic content data and allowing exchange of the same with each other, as well encouraging the usage thereof.

### Solution to Problem

The object is achieved by a communication system for communication between a plurality of users, the communication system including a distributed ledger unit, a communication management unit, and a plurality of user information terminals, which are all interconnected by information communication technology. In this communication system, the distributed ledger unit is configured by distributed ledger technology to generate and store a fungible token and a non-fungible token, and to send and receive a fungible token and/or a non-fungible token between users, in accordance with an instruction from a user via a user information terminal. Each of the user information terminals includes a user-specific wallet unit for management of a fungible token and a non-fungible token, and is configured to be able to send to the distributed ledger unit an instruction in accordance with an input from a user to generate and store a fungible token and/or a non-fungible token, and to send and receive a fungible token and/or a non-fungible token between users. The communication management unit is configured to be able to acquire, and aggregate and analyze information on a processing result of a fungible token and/or a non-fungible token in the distributed ledger unit, as well as to output the information.

In another embodiment, the wallet unit of each of the user information terminals is provided with an authentication unit, and the authentication unit performs registration of user authentication information, storage of authentication information, and query for authentication information.

In another embodiment, the fungible token generated by the distributed ledger unit is configured to be sold or distributed to users as an electronic crypto asset that can be used only within the communication system. The electronic crypto asset serves as an “electronic toy coin” so to speak, within a virtual space that is the communication system according to the present invention.

In yet another embodiment, each of the user information terminals is configured to be able to store user-created electronic content data, and the wallet unit thereof is configured to be able to manage generation of a non-fungible token added as individual identification information to the electronic content data, addition of a non-fungible token to electronic content data, publication of electronic content data with a non-fungible token added thereto, and exchange of electronic content data with a non-fungible token added thereto between users.

The communication management unit can be configured to be able to acquire information on a processing result of a fungible token and/or a non-fungible token in the distributed ledger unit, to generate a ranking in terms of generation, transmission, and reception of a fungible token and/or a non-fungible token based on the acquired information, and to output the ranking through a user information terminal.

The wallet unit could be configured to be able to generate a webpage for receiving a fungible token and/or a non-fungible token, and a link to the webpage.

These communication systems are implemented by a program configured to be executable in the system.

### BRIEF DESCRIPTION OF DRAWINGS

FIG. 1 is an overall view of a communication system according to the present invention.

FIG. 2 is a view of a user information terminal used in the communication system according to the present invention.

FIG. 3 shows flowcharts of a communication program according to the present invention.

FIG. 4 shows flowcharts of a communication program according to the present invention.

FIG. 5 shows flowcharts of a communication program according to the present invention.

FIG. 6 is a view of a communication management unit used in the communication system according to the present invention.

FIG. 7 shows examples of display screens (with rankings displayed and a receiving basket set) on a user information terminal in an operating state of the communication system according to the present invention.

### DESCRIPTION OF EMBODIMENTS

### [Overview of Communication System]

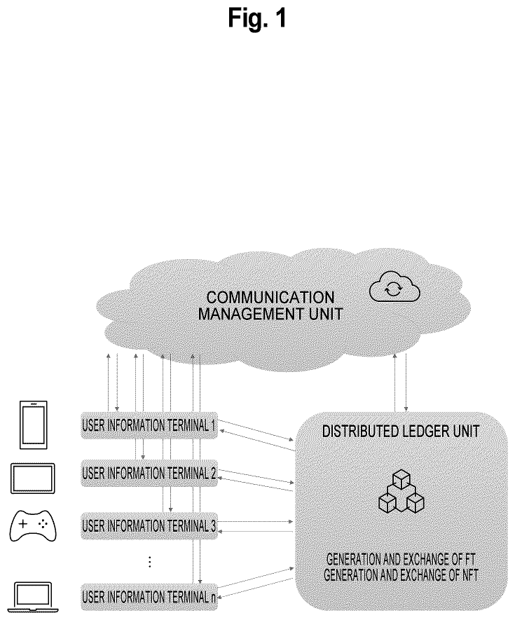

FIG. 1 shows an overall view of a communication system according to the present invention. As shown in FIG. 1, the communication system according to the present invention is made up of a distributed ledger unit, a communication management unit, and a plurality of user information terminals. These distributed ledger unit, communication management unit, and user information terminals are connected to each other by information communication technology (such as an Internet communication network), to be able to send and receive data and information to and from each other.

### [Overview of Distributed Ledger Unit]

First, the distributed ledger unit is described. The distributed ledger unit is configured using DAG-structured distributed ledger technology, for example, which is a distributed ledger technology called directed acyclic graph. DAG is expressed by edges (=arrows) starting from vertices. One or a plurality of edges starting from a vertex connect vertices, but never come(s) back to the original vertex. A blockchain has a continuous structure of blocks each linked to previous and successive ones. A DAG structure has an orientation without any limitation on the number of previous and successive blocks, and there is no particular limitation on the relationship between previous and successive blocks in a DAG structure. Another characteristic of DAG is that it does not require miners to mine, and users themselves perform individual PoW (Proof of Work) for transactions. Thus the structure overcomes the problems of scalability, transaction processing speed, and mining fees (transaction fees) in blockchain technology. As a result, there is no need to own crypto assets, or open accounts for them. The communication system according to the present invention, in particular, employs a tangle-type DAG-structured distributed ledger technology, which allows even young users to easily start using the system.

The distributed ledger unit is connected to user information terminals, and has the functionality to generate and exchange (send and receive) fungible tokens, FTs, upon instruction from the user information terminals. The distributed ledger unit further has the functionality to generate and exchange (send and receive) non-fungible tokens, NFTs, upon instruction from the user information terminals. How fungible tokens and non-fungible tokens are generated and exchanged will be described later in connection with the functions of a wallet unit provided in each user information terminal.

### [Overview of User Information Terminal]

As shown in FIG. 1, the communication system according to the present invention includes a plurality of user information terminals. FIG. 1 illustrates a total of n user information terminals, from user information terminal 1 to user information terminal n. These user information terminals can be a variety of devices such as smartphones, tablet terminals, portable game consoles, non-portable game consoles, TV receivers, PC terminals, and other electronic information communication terminals.

The user information terminals are configured to be able to communicate with the distributed ledger unit. The communication between each user information terminal and the distributed ledger unit may be wireless or wired communication achieved through an information communication network, such as an Internet communication network. As shown, each user information terminal is configured to be able to send information and data to the distributed ledger unit, and to receive information and data from the distributed ledger unit.

The user information terminals are configured to be able to communicate also with the communication management unit. Likewise, the communication between each user information terminal and the communication management unit may be wireless or wired communication achieved through an information communication network, such as an Internet communication network. As shown, each user information terminal is configured to be able to send information and data to the communication management unit, and to receive information and data from the communication management unit.

### [Overview of Communication Management Unit]

As shown in FIG. 1, the communication system according to the present invention includes the communication management unit. The communication management unit is configured to be able to communicate with each user information terminal and the distributed ledger unit, as mentioned above. Namely, the communication management unit is configured to be able to send and receive information and data to and from each user information terminal and the distributed ledger unit.

### [Details of User Information Terminal]

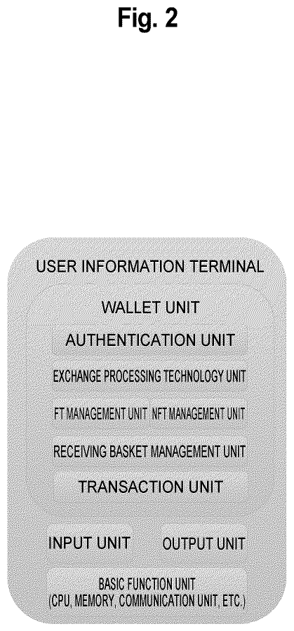

Next, the details of the user information terminal, and the functions and operations of its various units, are described with reference to FIG. 2. As shown in FIG. 2, the user information terminal includes a basic function unit, an input unit, an output unit, and a wallet unit.

### [Basic Function Unit of User Information Terminal]

The basic function unit is a component that provides the basic functions as a user information terminal, i.e., information processing function, information storage/reading function, communication function, and so on. For example, if the user information terminal is a smartphone, or a tablet terminal, or a PC, the basic function unit includes a means for performing operations on information such as a CPU, a means that allows for storage of information such as a volatile or non-volatile memory, HDD, or SSD, and a communication means such as a communication interface that allows for communication of information with other devices and subsystems such as the distributed ledger unit and communication management unit.

### [Wallet Unit of User Information Terminal]

As shown in FIG. 2, the user information terminal includes a wallet unit (also referred to as an electronic wallet, or electronic wallet unit). The wallet unit can be configured as an application that is downloaded and installed on the user information terminal. The wallet unit is configured to function as a tool for accessing the distributed ledger unit via communication technology, for performing various types of processing on the distributed ledger unit, and for receiving the information on the results of the processing from the distributed ledger unit.

For this reason, the wallet unit includes an authentication unit, an exchange processing technology unit, an FT management unit, an NFT management unit, a receiving basket management unit, and a transaction unit.

Other than being configured as an application that is downloaded and installed on the user information terminal, the wallet unit can of course be configured in a format available online.

### [Wallet Unit and Authentication Unit of User Information Terminal]

The authentication unit is a component that performs so-called authentication of a user using the communication system according to the present invention. Possible users of the communication system according to the present invention include individuals, corporations, and organizations. The authentication unit is configured to perform a process of registering authentication information at the user's first time of use, which is the personal information (name, affiliation, attributes, biometric information, etc.) when the user is an individual, and to perform the login authentication process each time the user uses this communication system thereafter. For corporation or organization users, the authentication unit is configured to allow registration of electronic authentication or electronic certification as authentication information at the first time of use, and to allow the information to be used for the authentication each time the organization uses this communication system thereafter.

Therefore, the authentication unit includes elements that can perform the registration of information (at the first time of use) and the authentication (at each login thereafter). Specifically, at the first time of use, the authentication unit transfers the authentication information input by the user to the communication management unit to be described later. The communication management unit records and stores this authentication information. This process will be described in more detail later. The authentication unit is configured to accept the authentication information input by the user when the user logs in thereafter to use the communication system, and to determine whether the user can log in by querying for the authentication information recorded and stored in the communication management unit and checking the input information against it. The authentication unit can be configured to perform the authentication in coordination with the distributed ledger unit instead of the communication management unit. Not to mention, recording and management of the authentication information are not limited to the method described here.

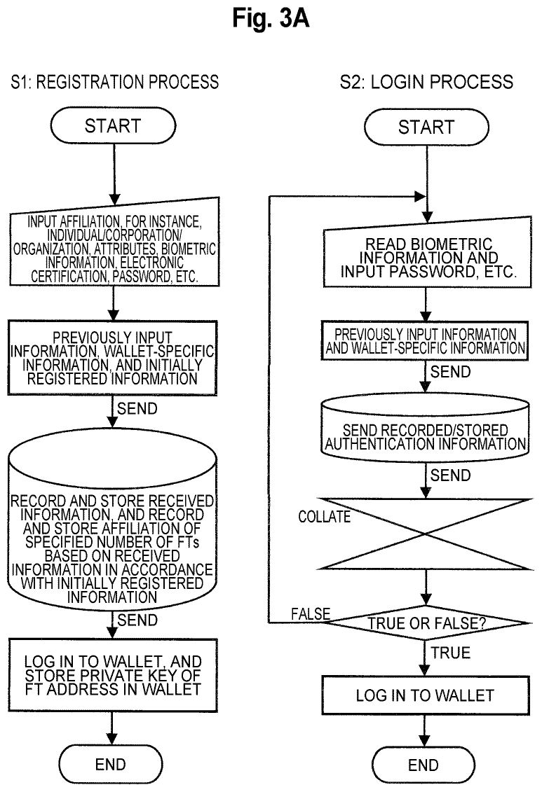

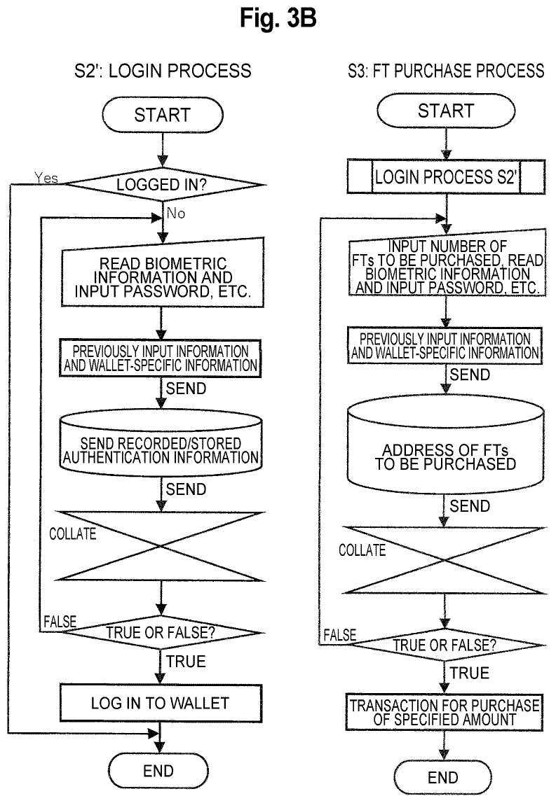

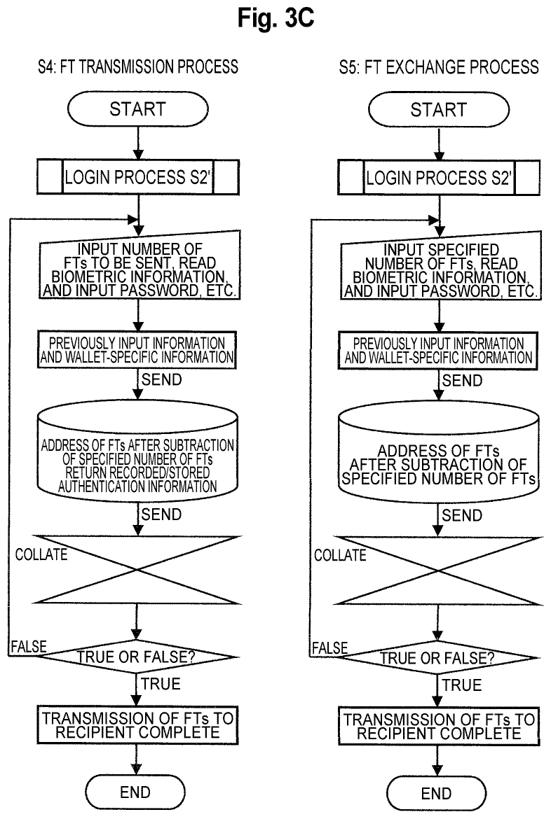

For reference, FIG. 3 shows flowcharts of more detailed process steps at the first time of use and when logging in after that. Needless to say, the registration of authentication information at first use, as well as the authentication at subsequent logins, can be performed according to these flowcharts.

### [Wallet Unit and Exchange Processing Technology Unit of User Information Terminal]

The wallet unit includes the exchange processing technology unit. The exchange processing technology unit enables the direct P2P sending and receiving of fungible and non-fungible tokens between user accounts via the wallet unit, through DEX and layer 2 technologies. For this reason, user accounts individually manage their private keys of the tokens.

### [Wallet Unit and FT Management Unit of User Information Terminal]

The wallet unit further includes the fungible token (FT) management unit. The fungible token management unit is configured to manage the generation (purchase), sending and receiving (exchange) of fungible tokens, and checking of the histories and results of these activities.

Fungible tokens are purchased (generated) through the FT management unit in the following manner. The user information terminal is configured to accept an input of a number of fungible tokens to be purchased via the input unit to be described later, as well as to allow a user to make payment for the consideration of the purchase. The terminal is configured to let the payment be made via the transaction unit. Having confirmed that a transaction has been carried out through the transaction unit, the FT management unit performs the process of generating fungible tokens via the distributed ledger unit. Specifically, the FT management unit encrypts the wallet identification information assigned to each wallet unit, the registration information (of an individual or corporation) registered in each wallet unit through the authentication unit, and any accompanying information as the ownership and affiliation information of the fungible tokens, records and stores it in the distributed ledger unit, and issues a private key. The ownership and affiliation of the fungible tokens are thus guaranteed and certified. The fungible tokens are generated by DAG-structured distributed ledger technology, for example, so that no fees are involved in generating the tokens.

In another possible configuration, a certain number of fungible tokens may be issued for free of charge at the first use (e.g., first authentication described above) of the communication system according to the present invention.

An upper limit may be set to the total number of fungible tokens that can be issued. For example, the upper limit of the total number of tokens that can be issued could be equal to an amount equivalent of the world's GDP for that year.

Fungible tokens are exchanged (sent and received) through the FT management unit in the following manner. When an instruction to send fungible tokens is input by a user via the input unit of the user information terminal, the FT management unit first has the authentication unit of the wallet unit perform user authentication. The registered authentication information of an individual, corporation, or organization is used for the user authentication. Thus the sender of the fungible tokens is identified. Next, the affiliation information of the recipient of the fungible tokens is identified. For the identification of the recipient's affiliation information, the wallet identification information of the receiving user, the authentication information (of an individual, corporation, or organization) of the recipient of the fungible tokens, and any accompanying information are used. These pieces of information are encrypted, and recorded and stored in the distributed ledger unit, whereupon a private key is issued. With the ownership and affiliation of the fungible tokens being thus guaranteed and certified, the process of sending and receiving the fungible tokens is complete.

For reference, FIG. 3 shows detailed flowcharts of a program for the purchasing, sending, and exchanging processes of fungible tokens. Fungible tokens can of course be purchased, sent, and exchanged in accordance with these flowcharts.

### [Wallet Unit and NFT Management Unit of User Information Terminal]

The wallet unit further includes the non-fungible token, NFT, management unit. The non-fungible token management unit is configured to generate non-fungible tokens, to add non-fungible tokens to electronic content data, to store non-fungible tokens, and to manage online information bulletin boards about the non-fungible tokens.

### [Generating and Adding NFT]

Non-fungible tokens are generated through the NFT management unit in the following manner. A user first prepares some user-created electronic content data and gives information on this electronic content data to the NFT management unit. The NFT management unit encrypts the provided electronic data information, the wallet identification information assigned to each wallet unit, the registration information (of an individual or corporation) registered in each wallet unit through the authentication unit, time stamp information (date and time when NFT was generated and added), and any accompanying information, as the non-fungible token information, records and stores it in the distributed ledger unit, and issues a private key. Thus a non-fungible token is generated and added to the electronic content data, which guarantees and certifies that this electronic content data is a unique non-replaceable creation by the user, as well as the ownership and affiliation of the data. The non-fungible token is generated and added by DAG-structured distributed ledger technology, for example, so that no fees are involved in generating the token. Various methods are possible to implement the function of generating and adding NFT in an actual application software (such as providing an NFT generating/adding tool button in an application software being used in the user information terminal).

### [Storage of NFT]

The NFT management unit can be provided with a space for storing electronic content data. This space is configured as an electronic information recording means such as a semiconductor memory, for example. This space is configured to be able to store the electronic content data to which a non-fungible token, NFT, has been added by the method described above. This space can of course be provided outside the NFT management unit. Various methods are possible to implement the function of storing NFT in an actual application software (such as providing an NFT storage button in an application software being used in the user information terminal).

### [Publication and Management of NFT]

The NFT management unit has the function of managing the publication or non-publication of electronic content data to which a non-fungible token, NFT, has been added. Specifically, this function is realized in coordination with the receiving basket management unit, which will be described later. For example, the NFT management unit can have the function of creating a public field (e.g., a public webpage) for the electronic data with the non-fungible token, NFT, and the link to this public field. The public field and the link may be made public on an electronic bulletin board by the receiving basket management unit that will be described later. Various methods are possible to implement the function of making NFT public in an actual application software (such as providing an NFT bulletin board button in an application software being used in the user information terminal).

[Exchanging Non-Fungible Token, NFT, with Fungible Token (FT)]

There can be a link to access a “receiving basket” that will be described later in the public field of the electronic data with the non-fungible token, NFT, described above. The electronic data with the non-fungible token (NFT) is thus associated with the receiving basket. The receiving basket is configured to allow specifying a number of fungible tokens equivalent to the consideration for the electronic data with non-fungible token (NFT) to be received in exchange (a number of fungible tokens the user must provide to receive the electronic data with non-fungible token, NFT). When a user who wishes to receive the electronic data with non-fungible token, NFT, inputs a number of fungible tokens that equals to the specified number, the authentication unit performs the user authentication process, whereby the owners of the non-fungible token and fungible tokens are identified. After that, the exchange processing technology unit instructs the distributed ledger unit to send and receive (exchange) the fungible tokens and the non-fungible token. The distributed ledger unit performs the process of changing the owners of the non-fungible token and the fungible tokens and returns the result to the wallet unit of each user. This establishes an exchange of the non-fungible token for the fungible tokens.

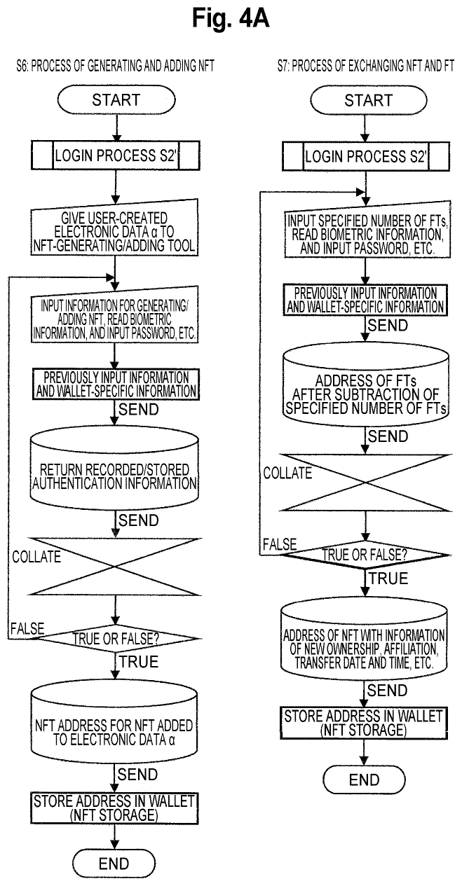

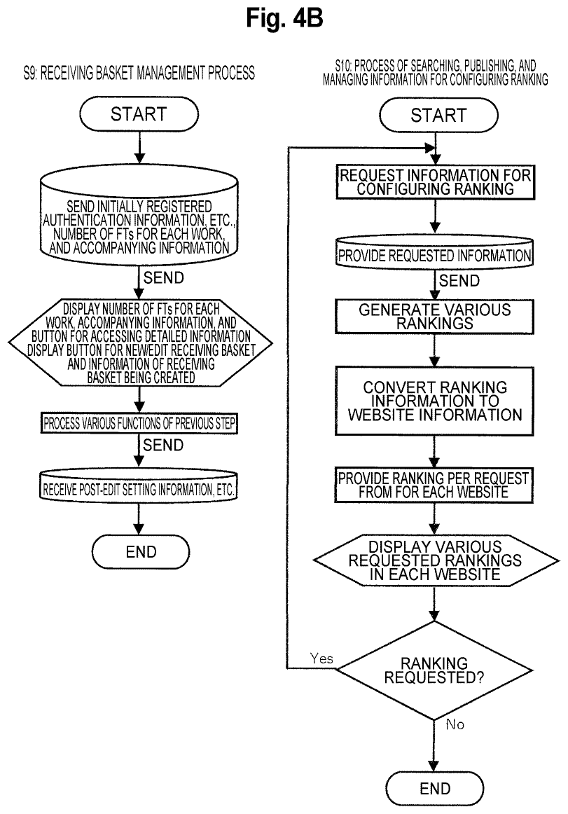

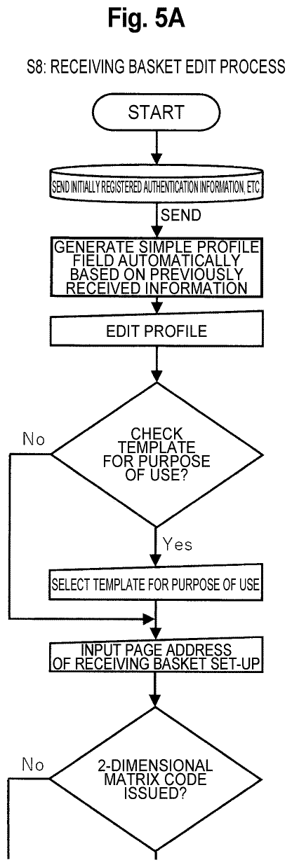

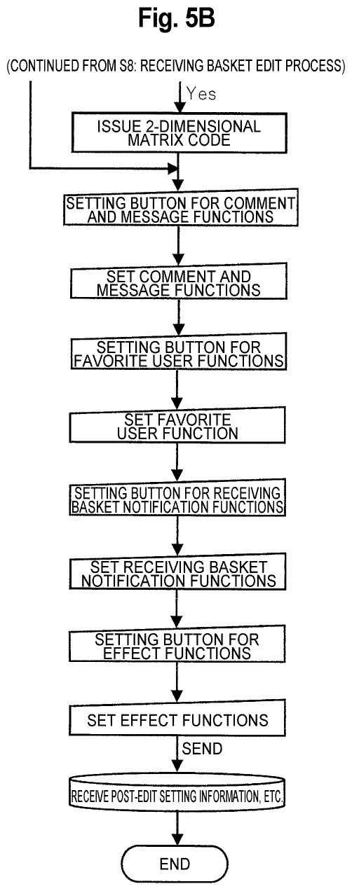

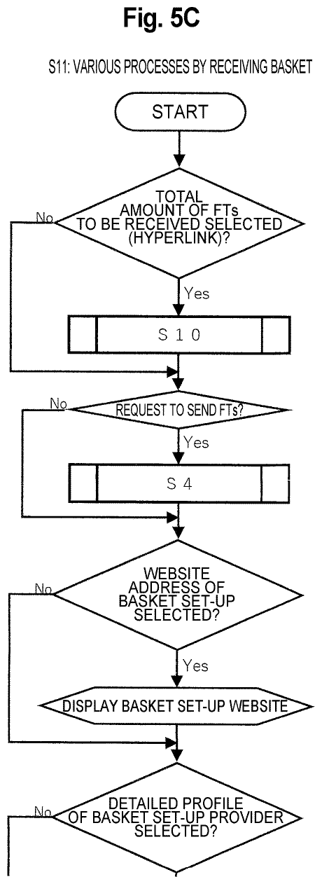

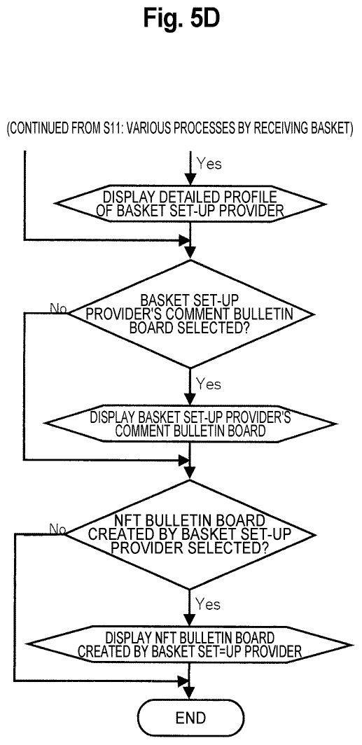

For reference, FIG. 4 and FIG. 5 show flowcharts of a program for exchanging non-fungible tokens, NFTs, and fungible tokens, FTs. Non-fungible tokens, NFTs, and fungible tokens, FTs, can of course be exchanged in accordance with these flowcharts.

### [Wallet Unit and Receiving Basket Management Unit of User Information Terminal]

The wallet unit further includes the receiving basket management unit. The “receiving basket” in this case is used as a term meaning a component that has at least the function of receiving a fungible token and/or a non-fungible token, and/or exchange a fungible token and a non-fungible token. Namely, the “receiving basket” has the function of receiving a fungible token (FT) and/or a non-fungible token from other users, and each user has such a receiving basket set up as a unique receiving basket of their own.

For example, the receiving basket management unit has the function of creating a webpage that has the functionality as the “receiving basket.” This webpage can be created within the communication management unit that will be described later, or in any give space on the web. The receiving basket management unit can be configured to create such a receiving basket webpage, as well as hyperlink URLs, link buttons, and/or two-dimensional matrix codes to this page. These hyperlink URLs, link buttons, and/or two-dimensional matrix codes can be placed in the SNS, video distribution services, and blogs the users each use, or their comment fields.

The receiving basket management unit can be configured to have the function of generating the receiving basket together with a clear indication of the purpose for which the receiving basket is to be used. For example, when the receiving basket is created as a webpage, this webpage indicates the purposes for which the receiving basket is to be used, i.e., transmission purposes when users send fungible tokens to the owner of the receiving basket via the receiving basket. There are three possible transmission purposes: (1) Transmission of fungible tokens for the purpose of supporting the activities of the receiving basket owner (support purpose); (2) Transmission for the purpose of exchange with the electronic data with non-fungible token owned by the user who is the receiving basket owner (exchange purpose); and (3) Transmission for the exchange with the electronic data with non-fungible token owned by the user who is the receiving basket owner in the form where the data is given to the one who seeks to provide the largest amount of fungible tokens (competitive transmission purpose). Namely, the website can be configured to allow users who intend to send fungible tokens to select one of these three purposes so as to send fungible tokens.

The receiving basket management unit can be configured to have the function of preventing the hyperlink URLs, link buttons, and/or two-dimensional matrix codes to the receiving basket from being wrongly set up.

The webpage configured as the receiving basket can include links to the webpage where the electronic data (electronic content data), for which the receiving basket is set up, is made public.

The receiving basket management unit is connected to the FT management unit and configured to implement the process of exchanging fungible tokens through the receiving basket management unit. Specifically, the receiving basket management unit is configured to allow other users to input a number of fungible tokens to be received from the other users. Namely, the receiving basket management unit is configured to perform the process of exchanging fungible tokens described above when a number of fungible tokens to be received by the recipient (who set up the receiving basket) is input through this input function.

### [Exchange of Comments and Messages via Receiving Basket Management Unit]

The receiving basket management unit can be configured to further include the function of allowing exchange of comments and messages with other users. Comments and messages can be exchanged in the form of text, pictures, photographs, sounds, movies, and so on, for example, via an electronic bulletin board where such comments and messages can be posted. This bulletin board can include the function of eliminating malicious posts by other users, or the posters themselves who post these malicious posts.

### [Adding Users as Favorites via Receiving Basket Management Unit]

The receiving basket management unit can have the function of performing the setting of allowing users to add other users as favorites (so-called “following”) or to be added by other users as favorites (“followed”), to exchange messages directly between users (“direct message”), or to notify favorite users (users they follow/followers) of an event.

### [Language Barrier-Free Environment via Receiving Basket Management Unit]

The receiving basket management unit can work with an external automatic translation system to implement a language barrier-free environment. This allows for exchange of messages and comments via the electronic bulletin board mentioned above, or exchange of direct messages between users added as favorites, irrespective of language. For reference, FIG. 4 and FIG. 5 show flowcharts of a program for the processing carried out by the receiving basket. Various types of processing by the receiving basket can of course be carried out in accordance with these flowcharts.

### [Communication Management Unit]

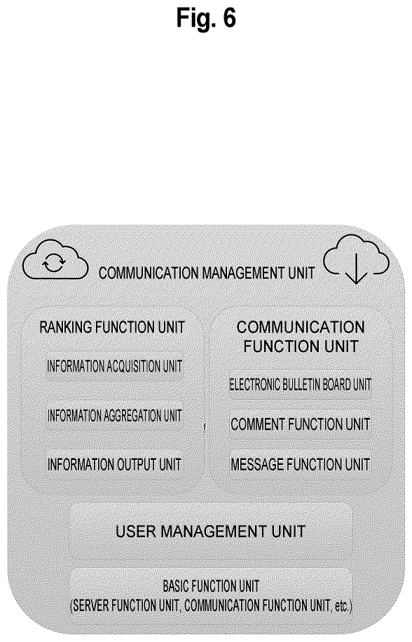

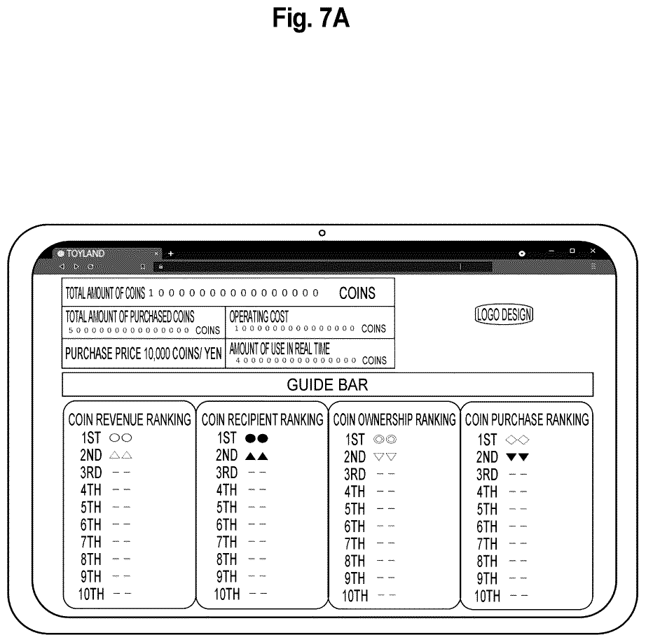

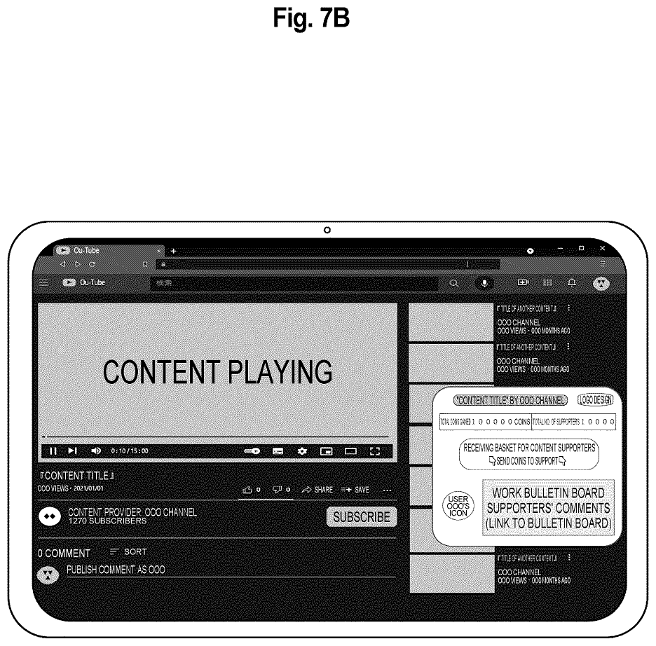

Next, the communication management unit in the communication system according to the present invention is described with reference to FIG. 6. As shown in FIG. 6, the communication management unit can be made up of a basic function unit, a user management unit, a communication function unit, and a ranking function unit. While the communication management unit is described as a component separate from the distributed ledger unit in the example here, the functions and structure of the communication management unit described below may naturally be implemented partly or entirely by the distributed ledger unit, too.

### [Basic Function Unit of Communication Management Unit]

The basic function unit is the part that implements the basic functions of the communication management unit. The communication management unit can for example be configured as a server on the web. In this case, the basic function unit includes the elements that implement the basic functions as a server, such as a means for performing operations and processing on information such as a CPU, a means that allows for storage of information such as a volatile or non-volatile memory, HDD, or SSD, and an information communication means that allows for exchange of information with the user information terminals and the distributed ledger unit.

### [User Management Unit of Communication Management Unit]

The communication management unit is provided with the user management unit. The user management unit can be configured to manage the information on the users of the communication system according to the present invention. For example, the user management unit manages the authentication information of each user. The authentication information each user registers via the authentication unit of the user information terminal at the first time of use of the communication system according to the present invention can be recorded and stored in this user management unit. In this case, the user management unit is configured to respond to the query for the authentication information from the authentication unit of the user information terminal when each user uses the system from the second time onward.

### [Ranking Function Unit of Communication Management Unit]

The communication management unit is further provided with the ranking function unit. The ranking function unit generates and publishes various rankings. The rankings are generated based on the information about the fungible tokens and non-fungible tokens sent and received. Therefore, the ranking function unit includes an information acquisition unit. The information acquisition unit can be formed as a common explorer script, for example. Namely, the information acquisition unit is configured to be connectable to the distributed ledger unit by means of information communication technology to acquire the information about the fungible tokens and non-fungible tokens recorded and stored in the distributed ledger unit, in particular the information about the sending and receiving of the tokens, and any accompanying information.

The ranking function unit further includes an information aggregation unit. The information aggregation unit is connected to the information acquisition unit, so that it receives the information acquired by the information acquisition unit and aggregates various rankings based on the information.

The rankings aggregated and analyzed by the information aggregation unit can include, for example, the following: Ranking of the amount of transmission and reception of fungible tokens; ranking of the number of people who sent fungible tokens to the receiving basket; ranking of the amount of fungible tokens purchased by corporations and individuals by donation or investment; ranking of the total amount of fungible tokens owned (gained and purchased); and rankings in terms of fungible tokens based on various categories, affiliations, or attributes. The rankings also include those specified or customized by users. That is, the rankings aggregated and analyzed by the information aggregation unit are not limited to those rankings listed above that are set or provided by the communication system, but can be various other rankings in accordance with user preferences.

The ranking function unit is further provided with an information output unit. The information output unit is configured to receive the ranking information aggregated and analyzed by the information aggregation unit, and to output and send it to a user information terminal in accordance with an instruction from the user information terminal. For reference, FIG. 4 shows a flowchart of a program for generating and outputting a ranking. A ranking can of course be generated and output in accordance with this flowchart.

In addition, the information output unit of the ranking function unit can be configured to be able to output other information than the ranking information. The information output unit is configured to be able to output and send the following information, for example, to user information terminals: All operating costs of the communication system according to the present invention, the total amount of fungible tokens issued, the total amount of fungible tokens purchased, the rate at which fungible tokens are purchased in major currencies (yen, dollar, euro, yuan, and other major legal tender), the total amount of fungible tokens being used in real time (e.g., automatically updated every 5 minutes).

The communication system according to the present invention allows users to receive, or purchase, fungible tokens distributed by the system provider as a crypto asset that can be used within the system. By using the communication system according to the present invention, users can generate a non-fungible token, add it to the digital content (electronic content data) created by themselves, and transfer (send) it to other users. The added non-fungible token guarantees the uniqueness of the electronic content data. In addition, users can easily exchange the fungible tokens as a crypto asset with electronic content data with a non-fungible token. Moreover, users can send fungible tokens as a gift to creators of digital content (electronic content data) simply for encouragement or support. The sending and receiving history of fungible and non-fungible tokens can be managed, aggregated, and ranked, which enables the early discovery of outstanding creators, excellent works, and those who provide significant support to these creators.

Users of all ages and genders can realize “communication, sharing of creations, mutual support and gratitude, excitement, talent discovery and development through sponsorship, corporate marketing, and easy access to NFT” through the donation of crypto assets (fungible tokens) that are toys (toy coins), and the use of non-fungible tokens, NFTs, and electronic wallets (toy baskets) or receiving baskets. This allows for hands-on learning of real crypto assets, NFTs, and electronic wallets, including preliminary practice in encountering potential dangers associated with them, freely in the realm of virtual reality (metaverse) without the worries of real-world taxation or monetary problems.

The present invention has been disclosed through embodiments as described above. The descriptions and drawings that form part of this disclosure are not intended to limit the present invention. Various alternative embodiments, examples, and operational techniques will be apparent from this disclosure to those skilled in the art. Therefore, the technical scope of the present invention is defined by the matters specifying the invention according to the valid scope of claims based on the above description.

1. A communication system for communication between a plurality of users, the communication system comprising:
a distributed ledger unit;
a communication management unit; and
a plurality of user information terminals,
which are all interconnected by information communication technology,
the distributed ledger unit being configured by distributed ledger technology to generate and store a fungible token and a non-fungible token, and to send and receive the fungible token and/or the non-fungible token between users, in accordance with an instruction from a user via a user information terminal,
each of the user information terminals including a user-specific wallet unit for management of the fungible token and the non-fungible token, and being configured to be able to send to the distributed ledger unit an instruction in accordance with an input from a user to generate and store the fungible token and/or the non-fungible token, and to send and receive the fungible token and/or the non-fungible token between users,
the communication management unit being configured to be able to acquire, and aggregate and analyze information on a processing result of the fungible token and/or the non-fungible token in the distributed ledger unit, as well as to output the information,
the plurality of user information terminals including a first user information terminal that selects, from among a plurality of transmission purposes including an exchange purpose for exchanging a fungible token with electronic data with a non-fungible token added thereto and owned by another user and including a support purpose for supporting another user, the exchange purpose, and
when the exchange purpose is selected, the first user information terminal accepting an input of a predetermined number of fungible tokens equivalent to a consideration for receiving the non-fungible token, and instructing the distributed ledger unit to send and receive the non-fungible token and the predetermined number of fungible tokens,
the distributed ledger unit sending and receiving the non-fungible token and the predetermined number of fungible tokens in accordance with the instruction to send and receive given by the first user information terminal when the exchange purpose is selected, and,
when the support purpose is selected from among the plurality of transmission purposes, the first user information terminal instructing the distributed ledger unit to send a fungible token, and the distributed ledger unit sending the fungible token in accordance with the instruction to send given by the first user information terminal when the support purpose is selected.

2. The communication system according to claim 1, wherein
the wallet unit of each of the user information terminals is provided with an authentication unit, and the authentication unit manages registration of user authentication information, storage of authentication information, and queries for authentication information.

3. The communication system according to claim 1, wherein
the fungible tokens accepting input of the number thereof are configured to be sold or distributed to users as an electronic crypto asset that can be used only within the communication system.

4. The communication system according to claim 1, wherein
each of the user information terminals is configured to be able to manage storage of user-created electronic content data, and the wallet unit thereof is configured to be able to manage generation of a non-fungible token added as individual identification information to the electronic content data, addition of a non-fungible token to electronic content data, publication of electronic content data with a non-fungible token added thereto, and exchange of electronic content data with a non-fungible token added thereto between users.

5. The communication system according to claim 1, wherein
the communication management unit is configured to be able to acquire information on a processing result of the fungible token and/or the non-fungible token in the distributed ledger unit, to generate a ranking in terms of generation, transmission, and reception of the fungible token and/or the non-fungible token based on the acquired information, and to manage output of the ranking through a user information terminal.

6. The communication system according to claim 5, wherein
the information on a processing result includes information on a processing result of transmission and reception in accordance with the instruction to send and receive given by the first user information terminal, and
the communication management unit generates a ranking in terms of transmission and reception of the fungible token and/or the non-fungible token.

7. (canceled)

8. The communication system according to claim 1, wherein
the wallet unit is configured to be able to generate a webpage for receiving the fungible token and/or the non-fungible token, and a link to this webpage, and
the first user information terminal instructs to send and receive the non-fungible token and the predetermined number of fungible tokens via the webpage.

9. The communication system according to claim 1, wherein
the distributed ledger unit is configured by distributed ledger technology including a directed acyclic graph structure.

10. A program configured to be executable in the communication system according to claim 1.
